(19) United States
(12) Patent Application Publication
(10) Pub. No.: US 2012/0025719 A1
(43) Pub. Date: Feb. 2, 2012

(54) LED Tube and Drive Circuit thereof

(75) Inventor: CHUN-HUA CHENG, Taipei (TW)

(73) Assignee: EDISON OPTO CORPORATION, Taipei (TW)

(21) Appl. No.: 12/940,051

(22) Filed: Nov. 5, 2010

(30) Foreign Application Priority Data
Jul. 29, 2010 (TW) 099125117

(51) Int. Cl. H05B 37/02

(52) U.S. Cl. 315/185 R

(57) ABSTRACT

This present invention provides a lighting system. The lighting system is disposed in a lamp holder. The lighting system includes a transparent tube, a lighting module, two covers and a drive circuit. The lighting module is located inside the transparent tube. The lighting module includes a plurality of light emitting diodes (LEDs) formed in a substrate. Two covers seals two end of the transparent tube. The drive circuit is located outside the transparent tube to drive the lighting module.

### RELATED APPLICATIONS

This application claims priority to Taiwan Application Serial Number 099125117, filed Jul. 29, 2010, which is herein incorporated by reference.

### BACKGROUND

1. Field of Invention

The present invention relates to a lighting system. More particularly, the present invention relates to a lighting system with an isolated drive circuit.

2. Description of Related Art

The most important issues today are about energy saving, carbon emission reduction and the Greenhouse effect. A traditional bulb generates 0.683 Kg of CO2 emissions when one kilowatt-hour of electrical power is consumed by this bulb. Typically, 525 kilowatt-hours of electrical power are consumed by a bulb in one year, which will generate more carbon and increase the Greenhouse effect. Therefore, the trend today is to replace the bulbs with light emitting diodes.

A light-emitting diode (LED) is a semiconductor light source. When a light-emitting diode is forward biased (switched on), electrons are able to recombine with holes within the device, releasing energy in the form of photons. This effect is called electroluminescence and the color of the light (corresponding to the energy of the photon) is determined by the energy gap of the semiconductor. An LED is usually small in area (less than 1 mm²), and integrated optical components shape its radiation pattern and assist in reflection. LEDs present many advantages over incandescent light sources including lower energy consumption, longer lifetime, improved robustness, smaller size, faster switching, and greater durability and reliability. Light-emitting diodes are used in applications as diverse as replacements for aviation lighting, automotive lighting (particularly indicators) and in traffic signals. The current flows through LED determine its brightness.

A typical light-emitting diode (LED) tube has two types of specifications, T5 and T8. The T5 type LED tube has a tube diameter of ⅝ inches. The drive circuit with a transformer for driving the T5 type LED tube is disposed outside the LED tube. Therefore, when the T5 type LED tube is disposed in a typical lamp holder, an additional location in the lamp holder is required to locate the drive circuit. Moreover, it is also necessary to arrange the circuit again between the LED tube and the drive circuit. In other words, it is impossible to directly adapt the typical lamp holder to dispose the T5 type LED tube for lighting.

The tube diameter of the T8 type LED tube is larger than that of the T5 type LED tube. Therefore, the drive circuit with a transformer for driving the T8 type LED tube can be disposed either outside or inside the LED tube. When the drive circuit for driving the T8 type LED tube is disposed outside the LED tube, the same problem that happened in the T5 type LED tube also happens in the T8 type LED tube. Therefore, it is also impossible to directly adapt the typical lamp holder to dispose the T8 type LED tube for lighting. On the other hand, when the drive circuit for driving the T8 type LED tube is disposed inside the LED tube, although it is not necessary to arrange an additional location in the lamp holder to locate the drive circuit, it is still necessary to rearrange the circuit between the LED tube and the power supply. Moreover, because the LED module and the drive circuit are together sealed in the tube, a user can not know which one, the LED module or the drive circuit, is broken when the LED tube is not lighted. Therefore, the user needs to replace the whole LED tube, which is high cost. The foregoing problems limit the development of using the LED lamps to replace the typical fluorescent lamps.

Therefore, an LED tube that can be directly disposed in a typical lamp holder and easily to maintain as needed.

### SUMMARY

This present invention provides a lighting system using LED tube. The drive circuit is located outside the tube. Therefore, the LED module is isolated from the drive circuit. Therefore, the LED module and the drive circuit can be independently replaced, which is easy to maintain and low cost. Moreover, the LED module is free from the heat generated by the drive circuit, which can stable the light from the LED module.

This present invention provides a drive circuit for driving an LED lighting system. The drive circuit includes two charge/discharge circuits. The first charge/discharge circuit can smooth the input voltage to prevent the LED module from being instantly lighted. The second charge/discharge circuit can smooth the adjust voltage to prevent flash the LED module.

This present invention provides a lighting system. The lighting system is disposed in a lamp holder. The lighting system includes a transparent tube, a lighting module, two covers and a drive circuit. The lighting module is located inside the transparent tube. The lighting module includes a plurality of light emitting diodes (LEDs) formed in a substrate. Two covers seals two end of the transparent tube. The drive circuit is located outside the transparent tube to drive the lighting module.

In an embodiment, the LEDs are connected in series.

In an embodiment, the lighting system further comprises a heat sink located in the transparent tube. The heat sink is adhered to a surface not LEDs located of the substrate. Each cover further includes a pin to fix the transparent tube in the lamp holder.

In an embodiment, the lamp holder further includes a starter socket to connect to a power supply. The drive circuit can electrically connect to the power supply through the starter socket. The drive circuit has a barrel shell that can be located in the starter socket. A printed circuit board is located in the barrel shell. The drive circuit is formed in the printed circuit board. Two pins electrically connected to the drive circuit are extended from the printed circuit board and protrude out the barrel shell. When the barrel shell is located in the starter socket, the driver circuit is electrically connected to the starter socket through the two pins.

In an embodiment, the drive circuit further includes a first charge/discharge circuit, a rectifier and a second charge/discharge circuit. The first charge/discharge circuit is connected to a power supply. The rectifier is connected to the first charge/discharge circuit. The second charge/discharge circuit is connected to the first charge/discharge circuit. The rectifier is a bridge rectifier.

In an embodiment, the rectifier includes a first input end, a second input end, a third output end and a fourth output end. The first charge/discharge circuit includes a first resistor and a first capacitor connected the first resistor in series. The first capacitor includes a first connecting point and a second connecting point. The first connecting point is connected to the first resistor and the first input end of the rectifier. The second connecting point is connected to the second input end of the rectifier. The second charge/discharge circuit includes a second resistor and a second capacitor connected the second resistor in series. The second capacitor includes a first connecting point and a second connecting point. The first connecting point is connected to the second resistor and the third output end of the rectifier. The second connecting point is connected to the fourth output end of the rectifier.

Accordingly, in the lighting system, the drive circuit is located outside the tube and the LED module is located inside the tube. The drive circuit is designated to have a barrel shell that meets the size of the starter socket. Therefore, when the tube is disposed in a lamp holder, the drive circuit can be inserted in the starter socket. That is, no additional location in the lamp holder is required to locate the drive circuit. Moreover, because the drive circuit is inserted into the original starter socket, it is also not necessary to arrange the circuit between the LED module and the drive circuit again. In other words, the LED lighting system can use the typical lamp holder. On the other hand, the drive circuit includes two charge/discharge circuits. The first charge/discharge circuit can smooth the input voltage to prevent the LED module from being instantly lighted. The second charge/discharge circuit can smooth the adjust voltage to prevent flash the LED module.

### BRIEF DESCRIPTION OF THE DRAWINGS

The invention can be more fully understood by reading the following detailed description of the embodiments, with reference made to the accompanying drawings as follows:

FIG. 1A illustrates an LED lighting system according to an embodiment of the present invention.

FIG. 1B illustrates an appearance schematic diagram of a drive circuit according to an embodiment of the present invention.

FIG. 2 illustrates a schematic diagram of an LED tube that can be disposed in a typical lamp holder according to an embodiment of the present invention.

FIG. 3A illustrates a schematic diagram of a drive circuit according to an embodiment of the present invention.

FIG. 3B illustrates a schematic diagram of a drive circuit according to an embodiment of the present invention.

### DETAILED DESCRIPTION

A light-emitting diode (LED) is a semiconductor light source. When a light-emitting diode is forward biased (switched on), electrons are able to recombine with holes within the device, releasing energy in the form of photons. This effect is called electroluminescence and the color of the light is determined by the energy gap of the semiconductor. LEDs present many advantages over incandescent light sources including lower energy consumption, longer lifetime, improved robustness, smaller size, faster switching, and greater durability and reliability.

Accordingly, the present invention provides a lighting system using LED as lighting source. The lighting system is disposed in a lamp holder with a starter socket. According to the present invention, the drive circuit is located outside a transparent tube and the LED module is located inside the transparent tube. The drive circuit is designated to have a barrel shell that meets the size of the starter socket. When the transparent tube is disposed in the lamp holder, the drive circuit can be directly inserted into the starter socket. Therefore, the original circuit arrangement between the starter socket and the tube can be used to transfer drive voltage from the drive circuit to the LED module. That is, it is not necessary to arrange the circuit and design the lamp holder again. The lighting system of the present invention can use the typical lamp holder. Although a typical lamp holder is used in the following embodiment to explain the application of the lighting system of the present invention, the lighting system also can be applied in other kinds of lamp holder.

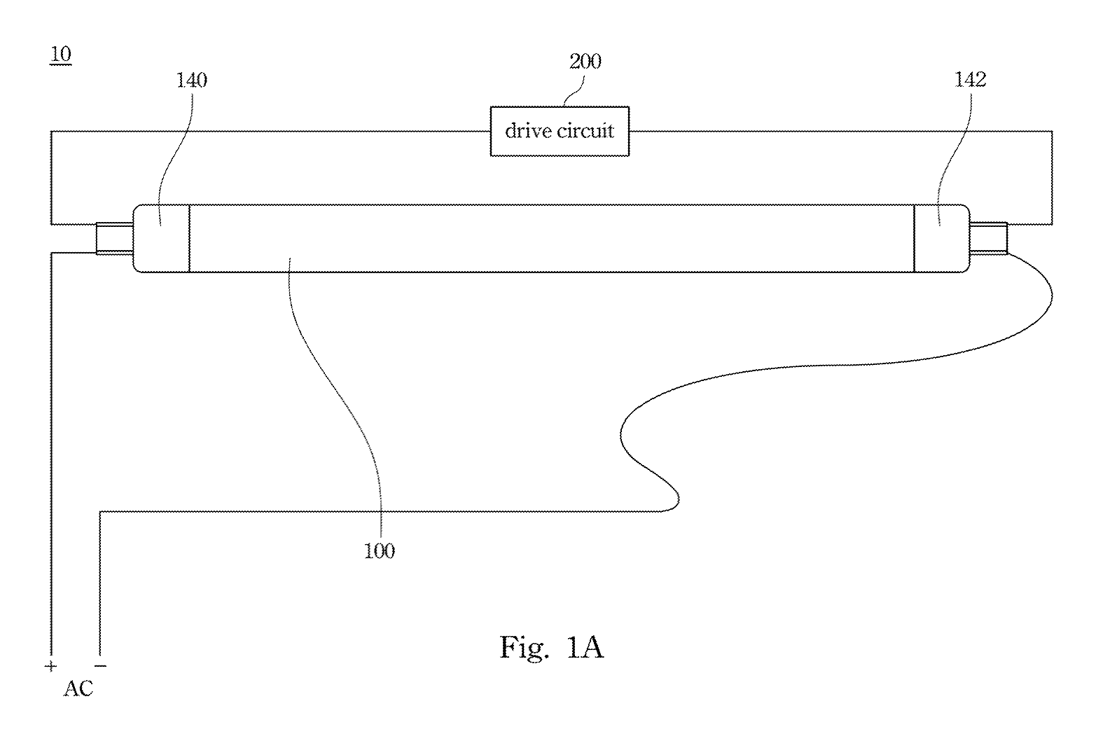

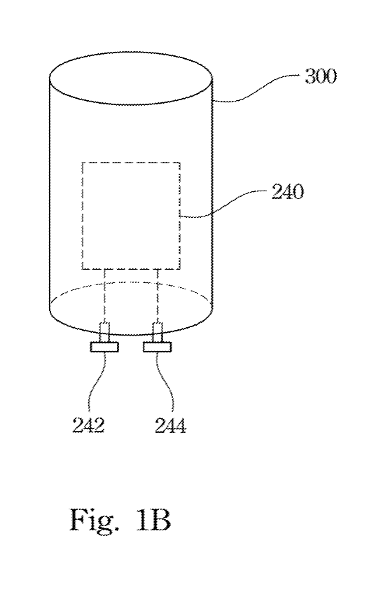

FIG. 1A illustrates an LED lighting system according to an embodiment of the present invention. The lighting system 10 includes an LED tube 100 and a drive circuit 200 separated from the LED tube 100. The LED tube 100 has two covers 140 and 142 that have pins electrically connected to the drive circuit 200. The drive circuit 200 drives the LED tube 100 through the pins on the covers 140 and 1423 respectively. The drive circuit 200 can be directly inserted into the starter socket to drive the LED tube 100. That is, there is no drive circuit inside the LED tube. An AC power supplies power to the LED tube 100 and the drive circuit 200.

In an embodiment, the drive circuit 200 is designated to have a barrel shell 300 that meets the size of the starter socket as shown in the FIG. 1B. A printed circuit board 240 is located in the barrel shell 300. The drive circuit 200 is formed in the printed circuit board 240. Two pins 242 and 244 electrically connected to the drive circuit 200 are extended from the printed circuit board 240 and protrude out the barrel shell 300. When the barrel shell is located in the starter socket, the driver circuit 200 is electrically connected to the starter socket through the two pins 242 and 244. That is, the AC poser supplies power to the drive circuit 200 through the starter socket. A Surface mount technology is used to fabricate the drive circuit 200. Therefore, the size of the drive circuit 200 is reduced. Accordingly, the lighting system of the present invention can use the typical lamp holder. The LED tube 100 can be disposed in the location that the original fluorescent tube is located, and the drive circuit 200 can be inserted into in the starter socket that the original starter is inserted. Therefore, the original circuit arrangement between the starter socket and the tube can be used to transfer drive voltage from the drive circuit 200 to the LED module 100. That is, the original structure of the typical lamp holder can be used in the lighting system of the present invention.

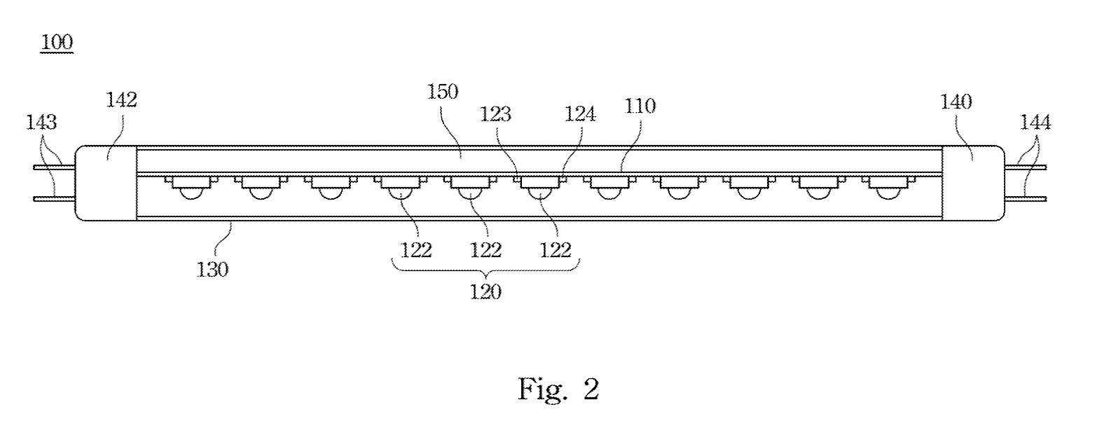

FIG. 2 illustrates a schematic diagram of a LED tube that can be disposed in a typical lamp holder according to an embodiment of the present invention. The LED tube 100 includes a lighting module 120 with a substrate 110, a transparent cover 130, two end covers 140 and 142 and a heat sink 150. The drive circuit 200 can be used to drive a street LED light, a T-B LED light, a T5 LED light, a T8 LED light, an electric ball LED lamp, AC LED lamp, or electric incandescent LED lamp.

Heat sink 150 has a half-cylinder appearance and is adhered to the inside surface of the top side of the LED tub 100. A conductive material, such as Cu, Al, is used to form the heat sink 150. Substrate 110 is adhered to the heat sink 150. An isolation layer formed between the substrate 110 and the heat sink 150 to isolate the substrate 110 and the heat sink 150. A heat conduction device can be also formed between the substrate 110 and the heat sink 150 to improve the heat conduction from the substrate 110 to the heat sink 150.

The lighting module 120 includes a plurality of LED 122 formed in the substrate 110. Each LED 122 has two pins 123 and 124 to connect to the corresponding connection points formed in the substrate 110. The LEDs 122 are connected in series and fixed in the substrate 110. The transparent cover 130 covers the substrate 110 to protect the LEDs 122. The LEDs 122 radiates light to pass through the transparent cover 130. The two covers 140 and 142 seals the LED tube 100 to prevent the substrate 110, the lighting module 120 and the heat sink 150 from dust and moisture damage. The two end covers 140 and 142 can help the LED tube fix in a lamp holder. On the other hand, pins 143 and 144 are formed in the two end covers 140 and 142 respectively to connect the LEDs 122 sealed in the LED tube 100 to a power supply.

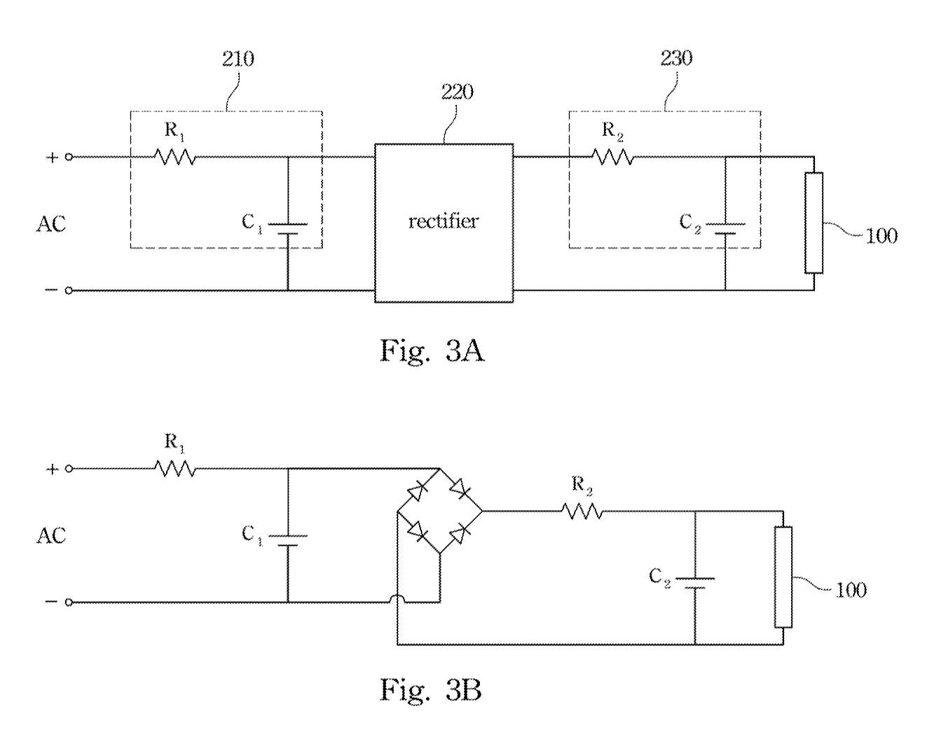

FIG. 3A illustrates a schematic diagram of a drive circuit according to an embodiment of the present invention. The drive circuit 200 includes a first charge/discharge circuit 210, a rectifier 220 and a second charge/discharge circuit 230. An Ac power supplied power to the drive circuit 200. The rectifier 220 can be a full-wave rectifier or a half-wave rectifier. In an embodiment, the rectifier 220 is a full-wave rectifier, such as a bridge rectifier, as shown in the FIG. 3B. Moreover, it is noticed that when the voltage supplied by the AC power can not meet the requirement of the lighting module, a transformer can be used to transform the voltage. For example, in this embodiment, the LEDs in the LED tube 100 are connected in series to receive the voltage from the drive circuit 200. However, in another embodiment, when the LEDs in the LED tube 100 are connected in parallel and the required voltage is less than the voltage that the drive circuit 200 can supply, a transformer can be used to transform the voltage to meet the required voltage of the LEDs connected in parallel in the LED tube 100.

The first charge/discharge circuit 210 includes a first resistor R1 and a first capacitor C1 connected the first resistor in series. In an embodiment, a TRIAC (TRIode for Alternating Current) is always used to adjust the luminance of the LEDs. The TRIAC can adjust the output current, the output voltage, phase of output current or phase of output voltage form the power supply to change the luminance of the LEDs. However, based on the inherent character of an LED, when the applied forward voltage is larger than the cut in voltage, an instant current is generated to light the LED. The unexpectedly instant current affects the efficiency of adjusting luminance. Therefore, in the present invention, the first charge/discharge circuit 210 is used to smooth the forward voltage applied to the LEDs. That is, the forward voltage charges the capacitor C1 before the forward voltage is applied to the LEDs. By the capacitor C1, the applied forward voltage is smoothed to prevent an instant current be generated.

On the other hand, when current or voltage adjusted by the TRIAC is unstable, the unstable current or voltage will make the LED flash. For example, when the current adjusted by the TRIAC is changed around the value to light the LED, the current will make the LED flash. Therefore, a second charge/discharge circuit 210 including a second resistor R2 and a second capacitor C2 connected the second resistor R2 in series is used to stable the adjusted current or voltage. That is, the adjusted current or voltage charges the second capacitor before the adjusted current or voltage is applied to the LED. The capacitor can smooth the change of the adjusted current or voltage to prevent the LED flash.

Surface mount technology (SMT) is a method for constructing electronic circuits in which the components, such resistor, capacitor, transistor, or Surface Mounted Components, are mounted directly onto the surface of printed circuit boards (PCBs). Electronic devices so made are called surface mount devices or SMDs. An SMT component is usually smaller than its through-hole counterpart because it has either smaller leads or no leads at all. In an embodiment, the Surface mount technology is used to fabricate the drive circuit, therefore, the volume of the drive circuit is reduced. That is, the drive circuit can be packaged in a barrel shell, and the barrel shell can be located in the starter socket.

Accordingly, using the drive circuit 200 of the present invention in a lighting system has the following advantages. First, the drive circuit 200 can smooth the current or voltage applied to the LEDs to improve the efficiency of adjusting the luminance. Second, the lighting system of the present invention can use the typical lamp holder. Therefore, the cost is low. Moreover, the Surface mount technology is used to fabricate the drive circuit, therefore, the volume of the drive circuit is reduced. That is, the weight and volume of the lighting system can be reduced.

An embodiment of using the drive circuit 200 to drive LEDs is described in the following paragraph. However, this embodiment can not limit the application of the present invention. The LEDs are connected in series. The total start voltage is the sum of start voltage of each LED because the LEDs are connected in series. The number of the LEDs must make the total start voltage larger than 110 volt or 220 volt. For example, when an LED has a 3.3 volt start voltage, the number of the LEDs can be 40 because the total start voltage of 40 LEDs is 132 volt that is larger than 110 volt. In other words, the 110 volt AC power supply can be directly applied to the 40 LEDs. Accordingly, no transformer is needed. Therefore, the size of the drive circuit can be reduced and the fabrication cost is low.

Accordingly, in the lighting system, the drive circuit is located outside the tube and the LEDs is located inside the tube. The drive circuit is designated to have a barrel shell that meets the size of the starter socket. Therefore, when the tube is disposed in a lamp holder, the drive circuit can be inserted in the starter socket. That is, no additional location in the lamp holder is required to locate the drive circuit. Moreover, because the drive circuit is inserted into the original starter socket, it is also not necessary to arrange the circuit between the LED module and the drive circuit again. In other words, the LED lighting system can use the typical lamp holder. On the other hand, the drive circuit includes two charge/discharge circuits. The first charge/discharge circuit can smooth the input voltage to prevent the LED module from being instantly lighted. The second charge/discharge circuit can smooth the adjust voltage to prevent flash the LED module.

Although the present invention has been described in considerable detail with reference to certain embodiments thereof, other embodiments are possible. Therefore, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A lighting system, wherein the lighting system is disposed in a lamp holder with a start socket, comprising:
a transparent tube;
a lighting module located inside the transparent tube, wherein the lighting module includes a plurality of light emitting diodes (LEDs) formed in a substrate, the light emitting diodes are connected in series;
two covers for sealing two ends of the transparent tube; and
a drive circuit located outside the transparent tube to drive the lighting module, wherein the drive circuit is located in the start socket and connected with a power supply.

2. The lighting system of claim 1, wherein the drive circuit is packaged in a barrel shell, the barrel shell can be located in the starter socket.

3. The lighting system of claim 2, further comprising a printed circuit board located in the barrel shell, wherein the drive circuit is formed in the printed circuit board.

4. The lighting system of claim 3, further comprising two pins electrically connected to the drive circuit, wherein the two pins are extended from the printed circuit board and protrude out the barrel shell, and when the barrel shell is located in the starter socket, the driver circuit is electrically connected to the starter socket through the two pins.

5. The lighting system of claim 1, wherein the drive circuit further comprises:
a first charge/discharge circuit coupling with the power supply;
a rectifier coupling with the first charge/discharge circuit; and
a second charge/discharge circuit coupling with the rectifier.

6. The lighting system of claim 5, wherein the rectifier is a bridge rectifier.

7. The lighting system of claim 5, wherein the rectifier comprises a first input end, a second input end, a third output end and a fourth output end.

8. The lighting system of claim 7, wherein the first charge/discharge circuit includes a first resistor and a first capacitor connected the first resistor in series, wherein the first capacitor includes a first connecting point and a second connecting point, and the first connecting point is connected to the first resistor and the first input end of the rectifier, and the second connecting point is connected to the second input end of the rectifier.

9. The lighting system of claim 8, wherein the second charge/discharge circuit includes a second resistor and a second capacitor connected the second resistor in series, wherein the second capacitor includes a first connecting point and a second connecting point, and the first connecting point is connected to the second resistor and the third output end of the rectifier, the second connecting point is connected to the fourth output end of the rectifier.
